(19) United States
(12) Patent Application Publication
(10) Pub. No.: US 2001/0014874 A1
(43) Pub. Date: Aug. 16, 2001

(54) Chart for representing data on stock selling and buying orders

(76) Inventors: Tatsuhide Iida, Tokyo (JP); Kayoko Iida, Tokyo (JP)

Correspondence Address: BIRCH STEWART KOLASCH & BIRCH, PO BOX 747, FALLS CHURCH, VA, 22040-0747, US

(21) Appl. No.: 09/776,628

(22) Filed: Feb. 6, 2001

(30) Foreign Application Priority Data
Feb. 7, 2000 (JP) P2000-029647

(51) Int. Cl. G06F 17/60

(52) U.S. Cl. 705/36

(57) ABSTRACT

A chart used to show the current price of stocks of a particular brand prevailing at a particular point of time of day, a limit price set by an investor for each selling or buying order not yet executed, and the number of stocks available at each set price is arranged to show those prices along the ordinate axis, and the number of stocks along the abscissa axis, and has a price range portion 10 formed by a segment 4 joining along the ordinate axis a single current price plot 1 representing the current price and one or more limit price plots 2a, 2b, . . . representing the limit price or prices set for a selling or buying order or orders, and a stock number representing portion 20 starting at each limit price plot 2a, 2b, . . . on the price range portion 10 and extending along the abscissa axis in accordance with the number of stocks corresponding to each limit price.

### BACKGROUND OF THE INVENTION

1. Field of the Invention

This invention relates to a chart for representing data on stock selling and buying orders, and particularly a chart which can present in an easily visually recognizable way the distribution of asked and bid prices based on selling and buying orders for the stocks of a particular brand of day.

2. Description of the Prior Art

A stock deal is concluded when the price is agreed upon between an investor who wants to sell stocks (hereinafter called the “seller”) and an investor who wants to buy stocks (hereinafter called the “buyer”). When an investor places an order for a deal in the stocks of a particular brand, he specifies sale or purchase, the number of stocks covered by his order, and the price, as is well known. The order in which the investor sets a selling (or buying) price is called a “limit order”. On the other hand, the order in which the investor does not set a price, but prefers the conclusion of a deal is called a “market order”.

Let it be supposed, for example, that a deal in the stocks of a brand, say, ““A” Electric Co., Ltd.” has just been concluded at a price of 400 yen (which is called the “current price” or “market price”). When there is a seller who wants to sell stocks of that brand at a limit price of 402 yen, this price is called the “asked price”. When there is a buyer who wants to buy at a limit price of 397 yen, this price is called the “bid price”. In addition to these prices, the number of stocks is made public with each price in a stock market. For example, “8000” as the number of stocks in a selling order at a price of 402 yen, or “12,000” as the number of stocks in a buying order at a price of 397 yen. Referring to a buying order for the stocks of ““A” Electric Co., Ltd.”, it is possible to buy up to 8000 stocks immediately at a price of 402 yen. In order to buy at a price of or below 401 yen, however, it is necessary to wait for the appearance of a seller who agrees to sell at that price. Actual stock dealings include a plurality of selling (or buying) orders placed at different limit prices, and the pricewise number of stocks ranges widely from blocks of 1000 to blocks of 100,000 or even more. These data on stock selling and buying orders are referred to as a “table”, and while they have hitherto been made public only on a computer system in a stock exchange, or in a securities company having a seat therein, they have come to be made public to the general investors, too, with the change of the times.

For the representation of a “table”, there has hitherto been available only a system in which the numbers of stocks in selling and buying orders not yet executed for the stocks of a particular brand are listed in parallel columns in the order of prices, and displayed in a screen with the current price, as shown in FIG. 5.

FIG. 6 explanatorily illustrates screens 51 displaying tables 52 for each of a plurality of brands of interest A, B, C and D to show data varying with the time T1, T2 or T3. It has hitherto been possible to display only the current data covering a single brand on a single screen, and it has, therefore, been considerably difficult to read instantly any change with time in the distribution of asked and bid prices for a single brand, or learn the current atmosphere of the market intuitively by looking at the asked and bid prices for a plurality of brands one after another.

### SUMMARY OF THE INVENTION

It is, therefore, an object of the present invention to overcome the problems as pointed out above and provide a chart which can represent the distribution of asked and bid prices for the stocks of a particular brand based on selling and buying orders of day in a easily visually recognizable way. It is another object of the present invention to provide a chart which can represent a change with time in the distribution of asked and bid prices for a brand, or the distribution of asked and bid prices for a plurality of brands at a time.

The above object of the present invention is attained by a chart for representing data on stock selling and buying orders and used to show the current price of stocks of a particular brand prevailing at a particular point of time of day, a limit price set by an investor for each selling or buying order not yet executed, and the number of stocks corresponding to the set price, the chart showing the prices along the ordinate axis, and the number of stocks along the abscissa axis, the chart comprising:

a price range portion formed by a segment joining along the ordinate axis a single current price plot representing the current price and one or more limit price plots representing the limit price or prices for a selling or buying order, and

a stock number representing portion starting at the limit price plots and extending along the abscissa axis in accordance with the numbers of stocks at the limit prices. The stock number representing portion preferably extends in the negative direction along the abscissa axis in the case of a selling order, and in the positive direction in the case of a buying order.

Another form of chart of a preferred embodiment according to the present invention comprises a display, on a single screen or sheet, of a plurality of charts as set forth in claim 1, and each of the plurality of charts being prepared for a single brand in time-series. Still another form of chart comprises a display, on a single screen or sheet, of a plurality of charts as set forth in claim 1, and each of the plurality of charts being prepared for a plurality of brands.

A chart according to the present invention can be realized as a display on a computer screen, or as an output in sheet form by, for example, installing a software containing a program for the preparation of a desired chart in a computer and inputting thereto through a line of communications, etc. the current price prevailing at a particular point of time of day, limit prices set by investors for selling or buying orders not yet executed, and the number of stocks corresponding to each limit price to make the computer to execute the program.

### BRIEF DESCRIPTION OF THE DRAWINGS

The invention will be explained in more detail in conjunction with appended drawings, wherein:

FIG. 1 is a view showing a chart of a preferred embodiment according to the present invention;

FIG. 2 is a view showing a display of a plurality of charts covering a plurality of brands on a single screen;

FIG. 3 is a view showing a display on a single screen of a plurality of charts prepared in time-series for a single brand;

FIG. 4 is a view showing different forms of charts embodying the present invention;

FIG. 5 is an explanatory view showing a conventional tabulated form of a “table” for representation; and

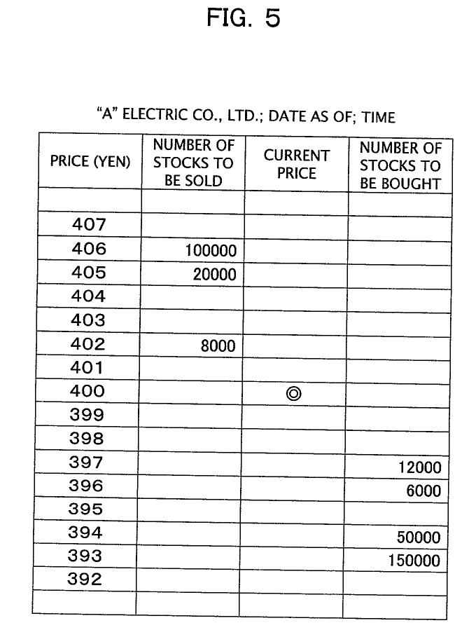

FIG. 6 is a view showing a change with time in a plurality of tabulated forms relating to a plurality of brands.

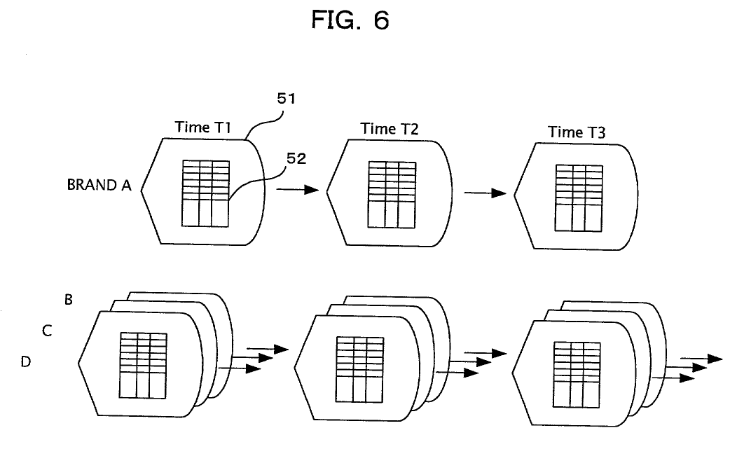

### DETAILED DESCRIPTION OF THE PREFERRED EMBODIMENTS

Description will now be made of some preferred embodiments of the present invention with reference to drawings.

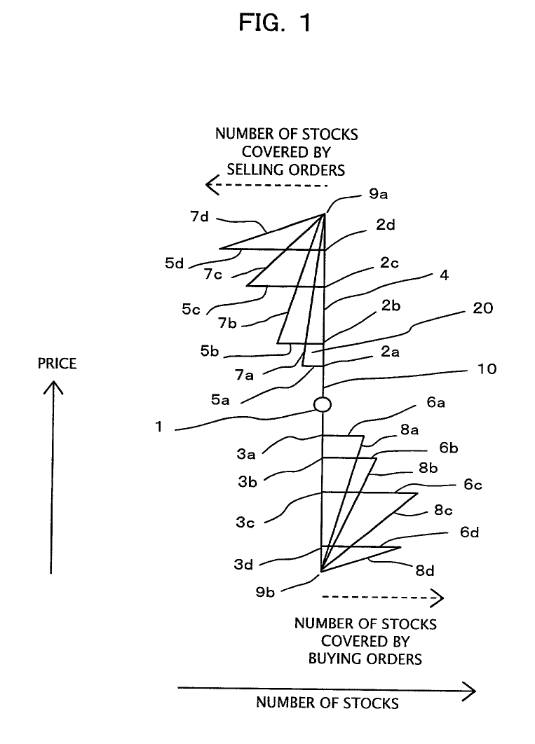

FIG. 1 is a diagram illustrating a chart for representing data on stock selling and buying orders in a preferred embodiment according to the present invention. It represents the current price for the stocks of a particular brand prevailing at a particular point of time of day, limit prices set by investors for selling or buying orders not yet executed, and the number of stocks for selling or buying orders at each limit price. In FIG. 1, the prices are shown along the ordinate axis and the number of stocks are shown along the abscissa axis.

The chart has a current price plot 1, a price range portion 10 and a plurality of stock number representing portions 20. The current price plot 1 indicates the current price at a particular point of time of day. The price range portion 10 is defined by a segment 4 joining along the ordinate axis (vertically) the current price plot 1, a plurality of limit price plots 2a, 2b, 2c, 2d indicating the prices for limit selling orders existing at that point of time and a plurality of limit price plots 3a, 3b, 3c, 3d indicating the prices for limit buying orders. While the current price plot 1 is shown by a white circle distinct from the segment 4, the limit price plots 2a, 2b, 2c, 2d, 3a, 3b, 3c, 3d are completely included in the segment 4 without being shown as discrete spots.

The stock number representing portions 20 are shown as described below. Referring to the limit price plot 2a on the price range portion 10, there are a segment 5a starting at the limit price plot 2a and extending in the negative direction along the abscissa axis by a length corresponding to the number of stocks ordered to be sold at the limit price, and a slanting line 7a joining the end of the segment 5a and the uppermost point 9a of the price range portion 10. There are likewise segments 5b, 5c, 5d and slanting lines 7b, 7c, 7d for the other limit price plots 2b, 2c, 2d indicating the limit prices set for the selling orders. Thus, each limit price plot is associated with a stock number representing portion 20 in the form of a right-angled triangle having a shape depending on the price and the number of stocks ordered to be sold.

Referring now to the limit price plots 3a, 3b, 3c, 3d indicating the limit prices set for the buying orders, there are likewise segments 6a, 6b, 6c, 6d extending along the abscissa axis each by a length corresponding to the number of stocks ordered to be bought at the limit price. The segments 6a, 6b, 6c, 6d, however, extend in the positive direction, and slanting lines 8a, 8b, 8c, 8d join the ends of the segments and the lowermost point 9b of the price range portion 10. As a result, it is understood that the stock number representing portions relating to the buying orders and the stock number representing portions relating to the selling orders have a positional relation similar to a relation of symmetry about the current price plot.

According to the chart of the preferred embodiment, the level of the segment extending from each limit price plot (or its position on the ordinate axis) represents the limit price set for a selling (or buying) order, or an asked (or bid) price, and the length of each segment and the direction in which it extends represent the number of stocks covered by an order and a distinction between selling and buying, respectively. It is, therefore, possible to learn the distribution of asked (or bid) prices and the number of stocks at those prices intuitively from a single compact diagram.

The chart according to the preferred embodiment as described above makes it possible to present, in a easily visually recognizable way, data covering stock selling and buying orders which corresponds to the conventional tabulated data and also has other advantages as will be stated below.

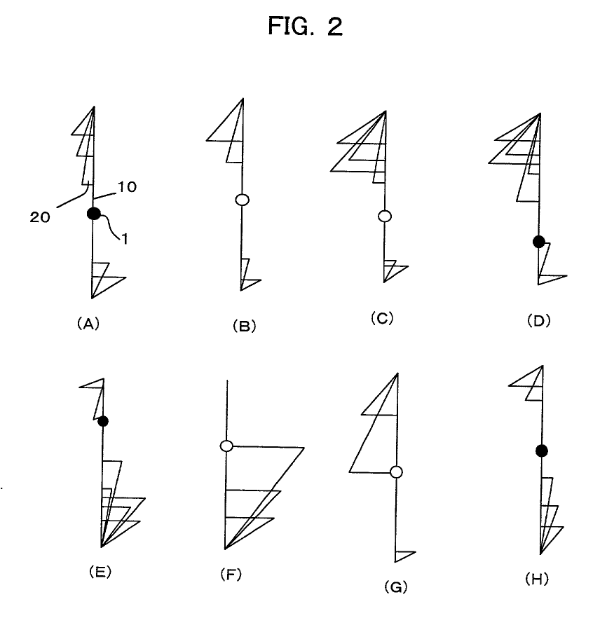

FIG. 2 shows an example of a display, on a single screen, of charts processed in accordance with the preferred embodiment as described above, based upon data on selling and buying orders existing at a particular point of time for the stocks of a plurality of brands A, B, C, D, E, F, G, H. It is understood that the mood of the market prevailing for each brand, for example, a strong selling mood for the brand C, D or G, or a strong buying mood for the brand E or F, can be presented by a single screen in such a way that by its viewer can easily understand.

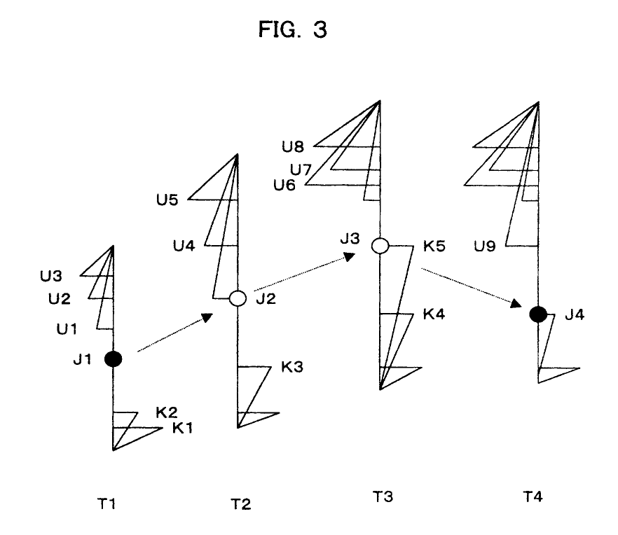

FIG. 3 shows another example of a display, on a single screen, of charts processed in accordance with the preferred embodiment as described above, based upon data on selling and buying orders existing for the stocks of a particular brand at different points of time T1 to T4 and the prices prevailing at those times. This example of display enables its viewer to have a visual understanding of the selling and buying demands varying with the passage of time. This example of display will now be described in further detail.

[Time T1]

At time T1, the current (or market) price is J1, and selling orders for which limit prices U1, U2, U3 have been set, and buying orders for which limit prices K1 and K2 have been set remain to be executed.

[From Time T1 to Time T2]

It is recognized that the selling order at price U1 has been executed (sale concluded), and the price has risen from J1 to J2. It is also recognized that there have been new selling orders at limit prices U4 and U5, while the buying order at price K1 has been canceled, there has been a slight increase in the number of stocks to be bought at price K2, and there has been a new buying order at a price K3.

[From Time T2 to Time T3]

The selling orders at prices U2, U3, U4 have been executed one after another, and the price has risen to J3. At J3, a buying order at a price K5 remains to be executed, but there have also been new big selling orders at prices U6, U7, U8 (a situation in which the price is unlikely to rise).

[From Time T3 to Time T4]

An investor has agreed to sell his stocks at the price J3 and the selling order at price K5 has been executed, but an order at a price U9 remains to be executed, as there have obviously been more stocks sold than bought. About a half of a buying order at K4 has been executed, though it is not known whether it has been a market order, or a limit order having a price set at K4, and the current price is J4.

According to FIG. 3, it is possible to show a change with time in the distribution of asked and bid prices for the stocks of a particular brand in a single display.

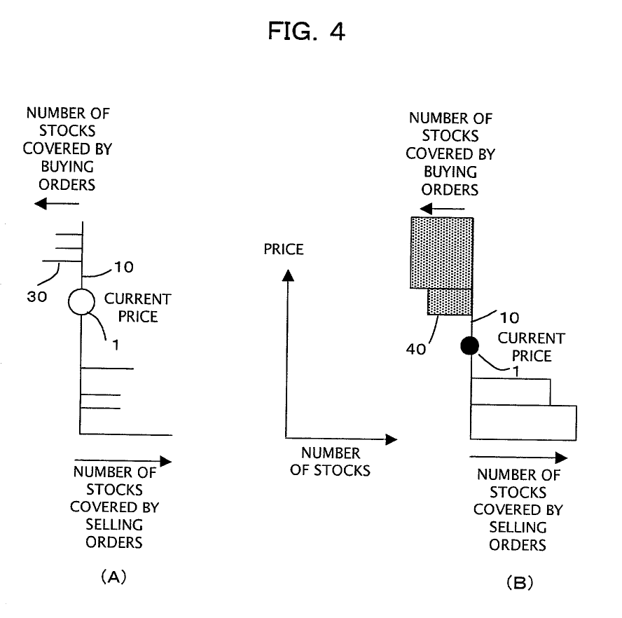

The chart according to the present invention is not limited to the form shown in FIG. 1, but may alternatively be in other forms as illustrated in FIG. 4. FIG. 4(A) shows an example in which each stock number representing portion 30 is defined by a single segment (or bar) starting at a limit price plot, and extending along the abscissa by a length corresponding to the number of stocks covered by an order at that price, and FIG. 4(B) shows another example in which a stock number representing portion 40 is defined by a band having a certain width in the direction of prices. In either event, a single compact diagram makes it possible to learn the distribution of asked (or bid) prices and the number of stocks for selling or buying orders at each such price intuitively.

By the way, the each current price plot 1 is shown by a white or black circle in FIGS. 1 to 4. The current price which has risen from the immediately preceding value is shown by a white circle, while that which has fallen is shown by a black one, so that it may be easy to know whether the current price has gone up or down from the immediately preceding value.

The price range portion 10 preferably has a length so selected that it may have its uppermost point situated at a level higher by a certain amount than the highest asked price to be displayed, and its lowermost point situated at a level lower by a certain amount than the lowest bid price, but is not limited as such. Thus, it is arbitrarily applicable to, for example, set a length of the price range portion based on a fixed price range having the current price in its middle portion (which range may be set as desired to cover, for example, plus or minus 10% of the current value), set the length based on a so-called “a restricted price range”, extend the price range portion upward or downward within the restricted price range until a balance is reached between the number of stocks covered by selling orders and the number of stocks covered by buying orders, or set the length in accordance with the magnitude of daily fluctuations in stock price up to the point of time at which it is displayed.

The stock number representing portions for each brand may be prepared in a large number to cover all of data on asked and bid prices as furnished by a securities company, etc., or may alternatively be limited in number by a certain standard. For example, it may be applicable to select and show only three of each of asked and bid prices that are closer to the current value (such prices may be considered as more realistic prices in the market).

A question may arise as to the handling of the number of stocks of any particular brand if it differs from one order to another so widely as, for example, from blocks of 1000 to 1,000,000 including blocks of 10,000 to 100,000. The same problem may occur to a display of a plurality of charts covering a plurality of brands. In any such event, it will be useful not to extend any stock number representing portion along the abscissa axis simply in proportion to the number of stocks, but to display any particularly large number of stocks on a reduced scale so determined as to enable the relative magnitudes of all the stock number representing portions to be properly presented. Moreover, it will be effective to employ different colors, designs or decorations for the stock number representing portions so that a wide difference in number may be easier to recognize.

The chart may, of course, further include a numerical representation of the limit price, or number of stocks covered by each order, or both as auxiliary data in the vicinity of each stock number representing portion.

The chart for representing data on stock selling and buying orders according to the present invention is a chart used to show the current price of stocks of a particular brand prevailing at a particular point of time of day, a limit price set by an investor for each selling or buying order not yet executed, and the number of stocks for selling or buying orders at each set price, the chart showing those prices along the ordinate axis, and the number of stocks along the abscissa axis, the chart having a price range portion formed by a segment joining along the ordinate axis a single current price plot representing the current price and one or more limit price plots representing the limit price or prices for a selling or buying order or orders, and a stock number representing portion starting at each limit price plot and extending along the abscissa axis in accordance with the number of stocks corresponding to each limit price, as described above. Thus, it can present, in an easily visually recognizable way, the distribution of asked and bid prices for stocks of any particular brand based on selling and buying orders on a particular day. As it can present information based on stock dealing data in a single compact diagram, it has the advantage of being easily applicable for making a single display of any change with time in the distribution of asked and bid prices for the stocks of a particular brand, or a single display of the distribution of asked and bid prices for the stocks of a plurality of brands. Therefore, it will furnish useful visual data to any general investor who may want to use data on stock selling and buying orders as an element for judgment in analysis for stock investment, and will be of great utility to the industry.

The preferred embodiment of the present invention has been disclosed by way of example and it will be understood that other modifications may occur to those skilled in the art without departing from the scope and the spirit of the appended claims.

What is claimed is:

1. A chart for representing data on stock selling and buying orders and used to show the current price of stocks of a particular brand prevailing at a particular point of time of day, a limit price set by an investor for each selling or buying order not yet executed, and the number of stocks corresponding to said set price, said chart showing said prices along the ordinate axis, and said number of stocks along the abscissa axis; the chart comprising:
a price range portion formed by a segment joining along the ordinate axis a single current price plot representing the current price and one or more limit price plots representing the limit price or prices for a selling or buying order or orders; and
a stock number representing portion starting at each said limit price plot and extending along the abscissa axis in accordance with the number of stocks corresponding to each limit price.

2. A chart according to claim 1, wherein said stock number representing portion extends in the negative direction along the abscissa axis in the case of a selling order, and in the positive direction in the case of a buying order.

3. A chart according to claim 2, wherein said stock number representing portion has a segment extending along the abscissa axis and having a length depending on the number of stocks, and a slanting line joining the end of said segment and the uppermost point of said price range portion in the case of a selling order, or a slanting line joining the end of said segment and the lowermost point of said price range portion in the case of a buying order.

4. A chart for representing data on stock selling and buying orders comprising a display, on a single screen or sheet, of a plurality of charts as set forth in claim 1, and each of said plurality of charts being prepared for a single brand in time-series.

5. A chart for representing data on stock selling and buying orders comprising a display, on a single screen or sheet, of a plurality of charts as set forth in claim 1, and each of said plurality of charts being prepared for each of a plurality of brands.
